(19) United States
(12) Patent Application Publication
(10) Pub. No.: US 2020/0131350 A1
(43) Pub. Date: Apr. 30, 2020

(54) BLOW MOLDED ARTICLES FORMED FROM POLYOLEFIN COMPOSITIONS

(71) Applicant: Braskem S.A., Camaçari (BR)

(72) Inventors: Bárbara Iria Silva Mano, São Paulo (BR); Marcelo Farah, São Paulo (BR); Mariele Kaipers Stocker, São Paulo (BR); Marcos Roberto Paulino Bueno, São Paulo (BR); Rafael Vilela Laurini, São Paulo (BR); Ronaldo Bollinelli Gomes, São Paulo (BR); Ana Paula Rodrigues Camilo, São Paulo City (BR)

(73) Assignee: Braskem S.A., Camaçari (BR)

(21) Appl. No.: 16/663,121

(22) Filed: Oct. 24, 2019

Related U.S. Application Data
(60) Provisional application No. 62/836,313, filed on Apr. 19, 2019.
(60) Provisional application No. 62/749,960, filed on Oct. 24, 2018.

(51) Int. Cl. C08L 23/06; B29C 49/00

(52) U.S. Cl. CPC C08L 23/06; B29C 49/0005; C08L 2207/02; C08L 2205/14; B29K 2105/16; C08L 2310/00; C08L 2205/025; C08L 2205/035; B29K 2023/06; C08L 2207/062

(57) ABSTRACT

A blow molded article may include a polymer matrix comprising virgin or recycled polyolefin; and one or more polymer particles dispersed in the polymer matrix, wherein the one or more polymer particles comprise a polar polymer selectively crosslinked with a crosslinking agent. The one or more polymer particles has an average particle size of up to 200 μm. Further, the blow molded article may possess improved ESCR, while maintaining stacking resistance, drop impact resistance, leakproofness, internal hydrostatic pressure resistance, and/or barrier to volatile organic compounds.

### CROSS-REFERENCE TO RELATED APPLICATIONS

This application claims priority to U.S. Patent Application Nos. 62/749,960, filed on Oct. 24, 2018, and 62/836,313, filed on Apr. 19, 2019, both of which are hereby incorporated by reference in their entirety.

### BACKGROUND

Polyolefins such as polyethylene (PE) and polypropylene (PP) may be used to manufacture a varied range of articles, including films, molded products, foams, and the like. Polyolefins may have characteristics such as high processability, low production cost, flexibility, low density and recycling possibility. However, physical and chemical properties of polyolefin compositions may exhibit varied responses depending on a number of factors such as molecular weight, distribution of molecular weights, content and distribution of comonomer (or comonomers), method of processing, and the like.

Methods of manufacturing may utilize polyolefin's limited inter- and intra-molecular interactions, capitalizing on the high degree of freedom in the polymer to form different microstructures, and to modify the polymer to provide varied uses in a number of technical markets. However, polyolefin materials may have a number of limitations, which can restrict application such as susceptibility to deformation and degradation in the presence of some chemical agents, and low barrier properties to various gases and a number of volatile organic compounds (VOC). Property limitations may hinder the use of polyolefin materials in the production of articles requiring low permeability to gases and solvents, such as packaging for food products, chemicals, agrochemicals, fuel tanks, water and gas pipes, and geomembranes, for example.

While polyolefins are utilized in industrial applications because of favorable characteristics such as high processability, low production cost, flexibility, low density, and ease of recycling, polyolefin compositions may have physical limitations, such as susceptibility to environmental stress cracking (ESC) and accelerated slow crack growth (SCG), which may occur below the yield strength limit of the material when subjected to long-term mechanical stress. Environmental stress cracking is a typical brittle fracture caused under a tensile stress lower than the tensile strength of a resin (material). Polyolefin materials may also exhibit sensitivity to certain groups of chemical substances, which can lead to deformation and degradation. As a result, chemical sensitivities and physical limitations may limit the success in the replacement of other industry standard materials, such as steel and glass, with polyolefin materials because the material durability is insufficient to prevent chemical damage and spillage.

In particular, environmental stress cracking is a phenomenon where a molded article develops brittle cracks with time due to a synergistic action of chemicals and stress when chemicals such as chemical substances attach to or contact a portion loaded with a tensile stress (a stressed portion).

Conventionally, methods of altering the chemical nature of the polymer composition may include modifying the polymer synthesis technique or the inclusion of one or more comonomers. However, modifying the polyolefin may also result in undesirable side effects. By way of illustration, increasing the molecular weight of a polyolefin may produce changes in the SCG and ESC, but can also increase viscosity, which may limit the processability and moldability of the polymer composition.

Other strategies may include inclusion of a comonomer and/or blending polyolefins with other polymer classes and additives to confer various physical and chemical attributes. For example, polyolefins may be copolymerized with alpha-olefins having a lower elastic modulus, which results in a considerable increase in environmental stress cracking resistance (ESCR) and impact resistance but adversely affects the stiffness of the polymer. However, the use of alpha-olefins may have limited effectiveness because, while the incorporation of alpha-olefin comonomers must occur in the high molecular weight fraction in order to affect ESC and impact resistance, many popular catalyst systems have a low probability of inserting alpha-olefins in the high molecular weight fraction, an important factor in forming “tie molecules” between the chains of the surrounding polyolefin that are responsible for transferring stress between the crystalline regions and, consequently, responsible for important mechanical properties. The end result is the production of a polymer composition having reduced structural stiffness. It is also noted that, while advances have developed catalysts that increase the likelihood of displacing the incorporation of a comonomer to the highest molecular weight range, and that multiple reactors may be used to address these limitations, such modifications are expensive alternatives and not wholly effective in balancing resistance to impact and ESC without negatively affecting stiffness.

Polymer modification by blending may vary the chemical nature of the composition, resulting in changes to the overall physical properties of the material. Material changes introduced by polymer blending may be unpredictable, however, and, depending on the nature of the polymers and additives incorporated, the resulting changes may be uneven and some material attributes may be enhanced while others exhibit notable deficits. The incorporation of a second phase into the matrix polymer, which generally has a different chemical nature, may increase the resistance to impact and ESC resistance in some cases. However, like the copolymerization strategy, polymer blends are often accompanied by a marked loss in stiffness, because the blended materials may have lower elastic modulus than the matrix polyolefin.

Accordingly, there exists a continuing need for developments blow molded products to have increases in environmental stress cracking resistance while balancing the mechanical properties of the article.

### SUMMARY

This summary is provided to introduce a selection of concepts that are described further below in the detailed description. This summary is not intended to identify key or essential features of the claimed subject matter, nor is it intended to be used as an aid in limiting the scope of the claimed subject matter.

In one aspect, embodiments of the present disclosure are directed to a blow molded article that includes a polymer matrix comprising a polyolefin; and one or more polymer particles dispersed in the polymer matrix, wherein the one or more polymer particles comprise a polar polymer selectively crosslinked with a crosslinking agent, where the one or more polymer particles has an average particle size of up to 200 μm.

In other aspects, embodiments of the present disclosure are directed to blow molded articles that include a masterbatch composition that includes a polymer matrix comprising a polyolefin; and one or more polymer particles dispersed in the polymer matrix, wherein the one or more polymer particles comprise a polar polymer selectively crosslinked with a crosslinking agent; and a secondary polymer that includes a polyolefin.

In another aspect, embodiments of the present disclosure are directed to process for preparing an article that includes blow molding a polymer composition to form a blow molded article that includes: a polymer matrix comprising a polyolefin; and one or more polymer particles dispersed in the polymer matrix, wherein the one or more polymer particles comprise a polar polymer selectively crosslinked with a crosslinking agent, and wherein the one or more polymer particles has an average particle size of up to 200 μm.

Other aspects and advantages of the disclosure will be apparent from the following description and the appended claims.

### BRIEF DESCRIPTION OF DRAWINGS

FIGS. 1-4 show the results of a burst test.

FIGS. 5 and 6 show the results of ESCR failure test.

### DETAILED DESCRIPTION

Embodiments of the present disclosure are directed to blow molded articles formed from polymer compositions, where the blow molded product has a balance of mechanical properties and environmental stress cracking resistance (ESCR). Conventionally, one is sacrificed at the expense of the other, but in the storage and transport of chemicals, such as but not limited to agrochemicals, detergents, etc., both properties are needed for the containers (often polyethylene) used to store and transport such chemicals. For example, the wall thickness of a high density polyethylene blow molded container is generally unavoidably increased in order to ensure the stacking resistance required at the time of filling of the content liquid, transporting and the like, thereby resulting in the increase of the amount of resins used. Conversely, when the wall thickness of a container is reduced in order to reduce the amount of resins used, a polyethylene resin having a high density and a high rigidity is required to be used in order to ensure the buckling strength. However, for conventional polyethylene resins, the container frequently cracks because of poor environmental stress cracking resistance (ESCR), which prevents the container from the practical application. Further, when a polyethylene resin has a high molecular weight in order to ensure the ESCR, the melt flow rate (MFR) decreases, thereby resulting in poor productivity because the fluidity at the time of molding is reduced. However, embodiments of the present disclosure use polymer compositions containing a mixture of polyolefin and polar polymer particles, which provides for improvement in ESCR without sacrificing stiffness and other mechanical properties in the formed articles, making those articles particularly suitable for blow molded containers used in the transport and storage of chemicals, including but not limited to agrochemicals, industrial chemicals and household chemicals.

Embodiments of the present disclosure are directed to blow molded articles formed from polymer compositions that include a matrix polymer phase containing polyolefin and one or more polar polymer particles dispersed in the matrix phase, where the polar polymer is crosslinked with a crosslinking agent that reacts selectively with functional groups present on the constituent polar polymer. In some embodiments, crosslinks generated in the polar polymer particles by the crosslinking agent may create structural and/or morphological changes that produce a polymer composition that may exhibit at least substantially similar physical and chemical characteristics when compared to a reference composition containing only the respective polyolefin, while also exhibiting gains in environmental stress cracking resistance. As defined here, “substantially similar” is defined to mean being within 20% of the value of any given property described herein relative to a reference composition (containing only the respective polyolefin). In one or more particular embodiments, the value of any given property described herein may be within 10% or 8% of that of the reference composition. That is, embodiments of the present disclosure may maintain a balance of mechanical properties and may also confer improved barrier properties to gases and liquids, while having a significant improvement on the environmental stress cracking resistance. Specifically, in one or more embodiments, the blow molded articles of the present disclosure may be formed from the polyolefin compositions described in U.S. Patent Publication No. 20170096552, which is herein incorporated by reference in its entirety.

In one or more embodiments, polyolefins may be blended with a polar polymer to adjust various physical and chemical properties of the final composition. Specifically, in one or more embodiments, physical and chemical properties of polymer compositions in accordance with the present disclosure may be modified by blending the polyolefin with a polar polymer having one or more functional groups that are selectively reacted with crosslinking agents, where the crosslinking occurs as or after the polyolefin and polar polymer are blended together, i.e., in the presence of but without reacting with the polyolefin. In some embodiments, in the blended polymer composition, the polar polymer may be in the form of sized particles having dimensions, such as less than 200 μm, suitable for end use applications. Thus, in the blended polymer composition, the polar polymer particles may be dispersed within a polyolefin matrix phase. Optionally, a functionalized polyolefin may be added as a compatibilizing agent, in addition to other additives. Processes of manufacturing polymer compositions in accordance with the present disclosure may include various blending methods such a solubilization, emulsion, suspension or extrusion.

In some embodiments, the polar polymer within the polymer composition may be crosslinked by a crosslinking agent to generate particulates containing intraparticle covalent linkages between the constituent polar polymer chains. Depending on the relative proximity of adjacent polar polymer particles (and concentration), it is also recognized that there may also be inter-particle covalent linkages that are formed. The crosslinked polar polymer particles may create changes in the physical and physicochemical properties, including increases in ESCR, while maintaining the balance of stiffness/impact resistance mechanical properties in relation to the properties of pure (unmodified or blended) polyolefins. The balance in properties may be expressed through a property balance index, which considers the combination of the flexural modulus, impact resistance and ESCR, discussed in greater detail below. The property balance index may be normalized against a reference polyolefin (without the polar polymer, etc.), and advantageously, the polymer compositions of the present disclosure may achieve a normalized property balance index that ranges from about 1.5 to 10, or from 3 to 6 in more particular embodiments.

In one or more embodiments, polymer compositions may be used in the manufacturing of articles, including rigid and flexible packaging for food products, chemicals, agrochemicals, fuel tanks, water and gas pipes, geomembranes, and the like.

Polyolefin

Polyolefin in accordance with the present disclosure may form a polymer matrix that surrounds other components in the polymer composition such as polar polymer particles and other additives. In one or more embodiments, polyolefins include polymers produced from unsaturated monomers (olefins or “alkenes”) with the general chemical formula of CₙH₂ₙ. In some embodiments, polyolefins may include ethylene homopolymers, copolymers of ethylene and one or more C3-C20 alpha-olefins, propylene homopolymers, heterophasic propylene polymers, copolymers of propylene and one or more comonomers selected from ethylene and C4-C20 alpha-olefins, olefin terpolymers and higher order polymers, and blends obtained from the mixture of one or more of these polymers and/or copolymers. In some embodiments, the polyolefins may include polymers generated from petroleum based monomers and/or biobased monomers (such as ethylene obtained from sugarcane derived ethanol). Commercial examples of biobased polyolefins are the “I'm Green”™ line of bio-polyethylenes from Braskem S.A. Particular embodiments may use high density polyethylene.

In one or more embodiments, matrix polymer may be selected from polyethylene with a density ranging from a lower limit selected from one of 0.890, 0.900, 0.910, 0.920, 0.930 and 0.940 g/cm³ to a higher limit selected from one of 0.945, 0.950, 0.960 and 0.970 g/cm³ measured according to ASTM D792 and a melt index (I₂) ranging from a lower limit selected from one of 0.01, 0.1, 1, 10 and 50 g/10 min to a higher limit selected from one of 10, 50, 60, 100, and 200 g/10 min according to ASTM D1238 at 190° C./2.16 kg and/or a melt index (I₂₁) ranging from a lower limit selected from one of 0.1, 1, 3, 5, 10 and 50 g/10 min to a higher limit selected from one of 10, 20, 30, 50, 60, 100, 500, and 1000 g/10 min according to ASTM D1238 at 190° C./21.6 kg. In one or more embodiments, the matrix polymer may include a high density polyethylene, with a density ranging from 0.935 g/cm³ to 0.970 g/cm³ according to ASTM D792, a melt index (I₂) ranging from 0.01 to 5 g/10 min according to ASTM D1238 at 190° C./2.16 kg and a melt index (I₂₁) ranging from 0.1 to 60 g/10 min according to ASTM D1238 at 190° C./21.6 kg. In particular, the high density polyethylene may have a density ranging from a lower limit of any of 0.935, 0.940, 0.945, or 0.950 to an upper limit of any of 0.960, 0.965, and 0.970 g/cm³, where any lower limit may be used in combination with any upper limit. In particular, the melt index (I₂) may range from a lower limit selected from one of 0.01, 0.05 and 0.1 g/10 min to a higher limit selected from one of 0.1, 1, 2, and 5 g/10 min according to ASTM D1238 at 190° C./2.16 kg where any lower limit can be used in combination with any upper limit. In particular, the melt index (I₂₁), measured according to ASTM D1238 at 190° C./21.6 kg, may have a lower limit of any of 0.1, 1, 2, 5, or 10, and an upper limit of any of 30, 40, 50, or 60 g/10 min, where any lower limit can be used in combination with any upper limit.

In one or more embodiments, the matrix polymer may include post consumer resin (PCR), post-industrial resin (PIR), and/or regrind. PCR refers to resin that is recycled after consumer use thereof, whereas PIR refers to resin that is recycled from industrial materials and/or processes (for example, cuttings of materials used in making other articles). When the materials are recovered directly from the same manufacturing process, the materials may be referred to as regrind. Generally, PCR may include resins having been used in rigid applications (such as PCR from previously blow molded articles, normally from 3D-shaped articles) as well as in flexible applications (such as from films). In one or more particular embodiments, the PCR or PIR used in the matrix polymer compositions may include PCR or PIR originally used in rigid applications. In particular, one or more embodiments of the present disclosure utilize HDPE (high density polyethylene) PCR or HDPE PIR. Often, such PCR or PIR may have a high amount of HDPE, though with the recycling process, it is understood that impurities may be present and that the material source may include a LDPE (low density polyethylene) or LLDPE or (linear low density polyethylene) or even PP (polypropylene). Thus, it is understood that the PCR or PIR may be a mixture of polyethylenes or polypropylenes, but is commonly predominantly HDPE.

In one or more embodiments, the matrix polymer may comprise a PCR, PIR or regrind with a melt index (I₂) that may range from a lower limit selected from one of 0.01, 0.05 and 0.1 g/10 min to a higher limit selected from one of 0.1, 1, 2, and 5 g/10 min according to ASTM D1238 at 190° C./2.16 kg where any lower limit can be used in combination with any upper limit and with a melt index (I₂₁), measured according to ASTM D1238 at 190° C./21.6 kg with may have a lower limit of any of 0.1, 1, 2, 5, or 10, and an upper limit of any of 30, 40, 50, or 60 g/10 min, where any lower limit can be used in combination with any upper.

In one or more embodiments, polymer compositions may contain a percent by weight of the total composition (wt %) of polyolefin ranging from a lower limit selected from one of 30 wt %, 40 wt %, 50 wt %, 60 wt %, 75 wt %, and 85 wt %, to an upper limit selected from one of 60 wt %, 75 wt %, 80 wt %, 90 wt %, 95 wt %, 99.5 wt % and 99.9 wt %, where any lower limit can be used with any upper limit.

Polar Polymers

Polymer compositions in accordance with the present disclosure may include one or more polar polymers that are combined with a polyolefin and, further, may be crosslinked by one or more crosslinking agents. As used herein, a “polar polymer” is understood to mean any polymer containing hydroxyl, carboxylic acid, carboxylate, ester, ether, acetate, amide, amine, epoxy, imide, imine, sulfone, phosphone, and their derivatives, as functional groups, among others. The polar polymer may be selectively crosslinked by an appropriate crosslinking agent, where the selective crosslinking may occur between the functional groups by reacting with a suitable crosslinking agent in the presence of polyolefins, additives, and other materials. Thus, the crosslinking agent is selected to react with the polar polymer but without exhibiting reactivity (or having minimal reactivity towards) the polyolefin (including any functionalized polyolefins present as a compatibilizing agent, discussed below). In particular embodiments, the polar polymer is a polymer comprising hydroxyl functional groups. In some embodiments, polar polymers include polyvinyl alcohol (PVOH), ethylene vinyl alcohol (EVOH) copolymer, and mixtures thereof. In particular embodiments, polar polymers include polyvinyl alcohol.

One or more polar polymers in accordance with the present disclosure may be produced by hydrolyzing a polyvinyl ester to produce free hydroxyl groups on the polymer backbone. By way of example, polar polymers produced through hydrolysis may include polyvinyl alcohol generated from the hydrolysis of polyvinyl acetate. The degree of hydrolysis for a polymer hydrolyzed to produce a polar polymer may be within the range of 30% and 100% in some embodiments, and between 70% and 99% in some embodiments.

Polar polymers in accordance with the present disclosure may have an intrinsic viscosity in the range of 2 mPa·s to 110 mPa·s in some embodiments, and between 4 mPa·s and 31 mPa·s in some embodiments. Intrinsic viscosity may be measured according to DIN 53015 using a 4% aqueous solution at 20 ° C.

In one or more embodiments, polar polymer in accordance with the present disclosure may form a distinct phase within the polymer composition, which may be in the form of particles having an average particle size of less than 200 μm. Particle size determinations may be made in some embodiments using SEM techniques after the combination with the polyolefin. Polar polymer particles in accordance with the present disclosure may have an average particle size having a lower limit selected from 0.01 μm, 0.5 μm, 1 μm, and 5 μm, and an upper limit selected from 10 μm, 20 μm, 30 μm, 50 μm, and 200 μm, where any lower limit may be used with any upper limit. Particle size may be determined by calculating relevant statistical data regarding particle size. In some embodiments, SEM imaging may be used to calculate particle size and develop size ranges using statistical analysis known for polymers and blends. Samples may be examined using SEM after hot pressing the samples in accordance with ASTM D-4703 and polishing the internal part of the plate by cryo-ultramicrotomy. Samples may be dried and submitted to metallization with gold. The images may be obtained by FESEM (Field Emission Scanning Electron Microscopy, Model Inspect F50, from FEI), or by Tabletop SEM (Model TM-1000, from Hitachi). The size of each crosslinked polar polymer particle may be measured from these images using the software LAS (version 43, from Leica). Calibration may be performed using the scale bar of each image and the measured values can be statistically analyzed by the software. The average value and standard deviation are given by the measurement of, at least, 300 particles.

In one or more embodiments, polymer compositions may contain a percent by weight of the total composition (wt %) of polar polymer ranging from a lower limit selected from one of 0.1 wt %, 0.25 wt %, 0.5 wt %, 1 wt %, 2 wt %, 5 wt %, 10 wt %, 15 wt %, and 25 wt %, to an upper limit selected from one of 5 wt %, 10 wt %, 15 wt %, 25 wt %, 50 wt %, 60 wt %, and 70 wt %, where any lower limit can be used with any upper limit.

Functionalized Polyolefin

In some embodiments, compatibilizing agents such as functionalized polyolefins may be added to modify the interactions between the polyolefin and the polar polymer. As used herein, “functionalized polyolefin” (or compatibilizing agent) is understood to mean any polyolefin which had its chemical composition altered by grafting or copolymerization, or other chemical process, using polar functionalizing reagents. Functionalized polyolefins in accordance with the present disclosure include polyolefins functionalized with maleic anhydride, maleic acid, acrylic acid, methacrylic acid, itaconic acid, itaconic anhydride, methacrylate, acrylate, epoxy, silane, ionomers, and their derivatives, or any other polar comonomer, and mixtures thereof, produced in a reactor or by grafting.

In one or more embodiments, polymer compositions may contain a percent by weight of the total composition (wt %) of functionalized polyolefin ranging from a lower limit selected from one of 0.1 wt %, 0.5 wt %, 1 wt %, and 5 wt %, to an upper limit selected from one of 5 wt %, 7.5 wt %, 10 wt %, and 15 wt %, where any lower limit can be used with any upper limit.

Crosslinking Agent

In one or more embodiments, a crosslinking agent may be used to crosslink a selected polymer phase in a polymer composition. As used herein, a “crosslinking agent” is understood to mean any bi- or multi-functional chemical substance capable of reacting selectively with the polar groups of a polymer, forming crosslinks between and within the constituent polymer chains. As used herein, “selective” or “selectively” used alone or in conjunction with “crosslinking” or “crosslinked” is used to specify that the crosslinking agent reacts exclusively with the polar polymer, or that the crosslinking agent reacts with the polar polymer to a substantially greater degree (98% or greater, for example) than with respect to the polyolefin polymer. The crosslinking agent is considered non-reactive (or not substantially reactive) to polyolefin when a composition consisting of the polyolefin polymer and the crosslinking agent undergoes the same process conditions as a composition comprising the polyolefin, polar polymer, and crosslinking agent, and it does not present modifications (or presents variations within a value of 2% or lower) to rheology (complex viscosity), FTIR and ESCR compared to the polyolefin without the crosslinking agent, according to any applicable measurement method provided the same method is applied to the polyolefin and to the composition consisting of polyolefin and crosslinking agent.

In one or more embodiments, crosslinking agents in accordance with the present disclosure may include linear, branched, saturated, and unsaturated carbon chains containing functional groups that react with counterpart functional groups present on the backbone and termini of a polar polymer incorporated into a polymer composition. In some embodiments, crosslinking agents may be added to a pre-mixed polymer blend containing a polyolefin and polar polymer particles, in order to crosslink the polar polymer in the presence of the polyolefin. Following addition to the pre-mixed polymer blend, a crosslinking agent may react with the polar polymer within the particles, creating intraparticle crosslinks between the polar polymer chains. Crosslinking agents in accordance with the present disclosure may include, for example, maleic anhydride, maleic acid and salts thereof, itaconic acid and salts thereof, itaconic anhydride, succinic acid and salts thereof, succinic anhydride, succinic aldehyde, adipic acid and salts thereof, adipic anhydride, phthalic anhydride, phthalic acid and salts thereof, glutaraldehyde, silanes, borax, their derivatives and mixtures thereof.

In one or more embodiments, crosslinking agents may be added to a blend used to form a polymer composition at a percent by weight (wt %) of the blend ranging from a lower limit selected from one of 0.001 wt %, 0.01 wt %, 0.05 wt %, 0.5 wt %, 1 wt %, and 2 wt % to an upper limit selected from one of 1.5 wt %, 2 wt %, 5 wt %, and 10 wt %, where any lower limit can be used with any upper limit.

Additives

In one or more embodiments, the polymer compositions of the present disclosure may contain a one or a number of other functional additives that modify various properties of the composition such as antioxidants, pigments, fillers, reinforcements, adhesion-promoting agents, biocides, whitening agents, nucleating agents, anti-statics, anti-blocking agents, processing aids, flame-retardants, plasticizers, stabilizers, light stabilizers, and the like.

Polymer compositions in accordance with the present disclosure may include fillers and additives that modify various physical and chemical properties when added to the polymer composition during blending. In one or more embodiments, fillers and nanofillers may be added to a polymer composition to increase the barrier properties of the material by increasing the tortuous path of the polymer matrix for the passage of permeate molecules. As used herein, “nanofiller” is defined as any inorganic substance with at least a nanometric scale dimension. Polymer composition in accordance with the present disclosure may be loaded with a filler and/or nanofiller that may include polyhedral oligomeric silsesquioxane (POSS), clays, nanoclays, silica particles, nanosilica, calcium nanocarbonate, metal oxide particles and nanoparticles, inorganic salt particles and nanoparticles, and mixtures thereof.

Fillers and/or nanofillers in accordance with the present disclosure may be incorporated into a polymer composition at a percent by weight (wt %) that ranges from 0.001 wt % and 5 wt % in some embodiments, and from 0.1 wt % to 2 wt % in some embodiments.

In one or more embodiments, polymer compositions may contain a percent by weight of the total composition (wt %) of one or more additives ranging from a lower limit selected from one of 0.001 wt %, 0.01 wt %, 0.05 wt %, 0.5 wt %, and 1 wt %, to an upper limit selected from one of 1.5 wt %, 2 wt %, 5 wt %, and 7 wt %, where any lower limit can be used with any upper limit.

Polymer compositions in accordance with the present disclosure may be formulated as a “masterbatch” in which the polymer composition contains concentrations of polar polymer that are high relative to the polar polymer concentration in a final polymer blend for manufacture or use. For example, a masterbatch stock may be formulated for storage or transport and, when desired, be combined with additional polyolefin or other materials in order to produce a final polymer composition having concentration of constituent components that provides physical and chemical properties tailored to a selected end-use.

One or more of the wt % values mentioned above with respect to each of the components refer in fact to amounts that may be used to form such a masterbatch. In one or more embodiments, a masterbatch polymer composition may contain a percent by weight of the total composition (wt %) of crosslinked polar polymer ranging from a lower limit selected from one of 10 wt %, 20 wt % 25 wt %, 30 wt %, 40 wt %, and 50 wt % to an upper limit selected from one of 50 wt %, 60 wt %, and 70 wt %, where any lower limit can be used with any upper limit. Similarly, a masterbatch may include a polyolefin in an amount that ranges from a lower limit selected from 30 wt %, 40 wt %, and 50 wt % to an upper limit selected from one of 50 wt %, 60 wt %, 70 wt %, 75 wt %, 80 wt %, and 90 wt %, where any lower limit can be used with any upper limit. It is also envisioned that the functionalized polyolefin may be present at an amount ranging from a lower limit selected from one of 0.1 wt %, 0.5 wt %, 1 wt %, and 5 wt %, to an upper limit selected from one of 5 wt %, 7.5 wt %, 10 wt %, and 15 wt %, where any lower limit can be used with any upper limit. Fillers or other additives may also be included, as described above.

For example, when formulated as a masterbatch stock, the masterbatch may be combined with a secondary polymer composition to form the blowmolded article The secondary polymer may be selected from a polyolefin as defined above, which may be the same or different from the matrix polymer. Further, it is also envisioned that any of the secondary polymers may be at least partially biobased. In one or more embodiments, the secondary polymer composition (including any of the above) may be a virgin polymer resin, while in others embodiments, the secondary polymer resin is a post-industrial polymer resin (PIR), a post-consumer polymer resin (PCR), a regrind polymer resin or combinations thereof.

It is known from those skilled in the art that the recycling of polymeric materials is a major concern for the environment. Normally the recycling of PCR resins is difficult due to its poor ESCR property that limits the resin application. However, the addition of the crosslinked polymeric masterbatch as described in the present disclosure, even in very low concentrations, may enable the increase in ESCR property of PIR and PCRs, making it possible to reuse them even in applications that require high ESCR, which normally is impossible to achieve with recycled resins.

In particular embodiments, virgin polyolefins, PIRs, PCRs, regrind polymer resins and combinations thereof may be present in the polymer composition in an amount having a lower limit ranging from any of 70 wt %, 80 wt %, or 90 wt %, and an upper limit ranging from any of 95 wt %, 96 wt %, 97 wt %, 98 wt % 99 wt % or 99.5 wt % where any lower limit can be used in combination with any upper limit.

As noted, in the masterbatch composition, the polymer composition contains concentrations of polar polymer that are high relative to the polar polymer concentration in a final polymer blend for manufacture or use. Thus, prior to use to form a blowmolded article, the masterbatch composition may be combined with an additional quantity of polyolefin to arrive at a polar polymer concentration in the final composition that is lower than the masterbatch concentration. Further, when it is desirable to form a blowmolded article without use of a masterbatch composition, the lower quantities of crosslinked polar polymer and higher quantities of polyolefin (from the ranges mentioned above) may be used.

For example, a polymer composition that is to be used directly in the manufacture of a blowmolded article, without additional polyolefin added thereto, may contain a percent by weight of the total composition (wt %) of crosslinked polar polymer ranging from a lower limit selected from one of 0.5 wt %, 1 wt %, 2 wt %, and 5 wt %, to an upper limit selected from one of 5 wt %, 6 wt %, 8 wt %, 10 wt %, 15 wt %, 25 wt %, and 50 wt %, where any lower limit can be used with any upper limit. Similarly, such composition may include a polyolefin in an amount that ranges from a lower limit selected from 50 wt %, 75 wt %, 85 wt %, and 90 wt % to an upper limit selected from one of 85 wt %, 90 wt %, 95 wt %, 98 wt %, 99 wt %, and 99.5 wt %, where any lower limit can be used with any upper limit. It is also envisioned that the functionalized polyolefin may be present at an amount ranging from a lower limit selected from one of 0.1 wt %, 0.5 wt %, 1 wt %, 2 wt %, and 5 wt %, to an upper limit selected from one of 5 wt %, 7.5 wt %, 10 wt %, where any lower limit can be used with any upper limit. Fillers or other additives may also be included, as described above.

Polymer Composition Preparation Methods

Polymer compositions in accordance with the present disclosure may be prepared by a number of possible polymer blending and formulation techniques, which will be discussed in the following sections.

Extrusion

In one or more embodiments, polymer compositions in accordance with the present disclosure may be prepared using continuous or discontinuous extrusion. Methods may use single-, twin- or multi-screw extruders, which may be used at temperatures ranging from 100° C. to 270° C. in some embodiments, and from 140° C. to 230° C. in some embodiments. In some embodiments, raw materials are added to an extruder, simultaneously or sequentially, into the main or secondary feeder in the form of powder, granules, flakes or dispersion in liquids as solutions, emulsions and suspensions of one or more components.

The components can be pre-dispersed in prior processes using intensive mixers, for example. Inside an extrusion equipment, the components are heated by heat exchange and/or mechanical friction, the phases are melt and the dispersion occurs by the deformation of the polymer. In some embodiments, one or more compatibilizing agents (such as a functionalized polyolefin) between polymers of different natures may be used to facilitate and/or refine the distribution of the polymer phases and to enable the formation of the morphology of conventional blend and/or of semi-interpenetrating network at the interface between the phases. The crosslinking agent can be added at the same extrusion stage or in a consecutive extrusion, according to selectivity and reactivity of the system.

In one or more embodiments, methods of preparing polymer compositions may involve a single extrusion or multiple extrusions following the sequences of the blend preparation stages. Blending and extrusion also involve the selective crosslinking of the polar polymer in the dispersed phase of the polymer composition by the crosslinking agent.

Extrusion techniques in accordance with the present disclosure may also involve the preparation of a polar polymer concentrate (a masterbatch), combined with a crosslinking agent in some embodiments. The masterbatch may then be combined (or diluted) with other components, such as a secondary polymer, in a subsequent extrusion step, to produce a polymer composition of the present disclosure. In some embodiments, the morphology of a crosslinked polar polymer may be stabilized by crosslinking when dispersed in a polymer matrix containing polyolefins and is not dependent on subsequent processes for defining the morphology.

As mentioned above, embodiments of the present disclosure further encompass blow molded articles that have at least one layer formed from the aforementioned polymer composition. One or more embodiments include a monolayer blow molded article, while one or more other embodiments include a multilayer blow molded article. In multilayer blow molded articles, at least one layer is formed from the polymer composition of the present disclosure.

Polymer compositions prepared by extrusion may be in the form of granules that are applicable to different molding processes, including processes selected from extrusion blow-molding, injection blow molding, stretch blow molding (SBM), ISBM (Injection Stretch Blow-Molding), foam blow molding and the like, to produce manufactured articles.

The resin composition of the present disclosure having improved environmental stress cracking resistance properties may be molded into blow molded articles. In particular embodiments, the disclosure relates to blow molded articles. These molded articles include articles (multilayer structures or the like) that contain a part consisting of the resin composition having improved environmental stress cracking resistance properties and a part consisting of other resins. The polymer composition of the present disclosure having improved environmental stress cracking resistance properties exhibits excellent environmental stress cracking resistance particularly when the resin composition is used for blow molded articles among the above molded articles, and the resin composition is suitably used for the applications such as fuel tanks, cans for industrial chemicals (particularly agrochemicals), bottle containers such as bleacher containers, detergent containers, softener containers, containers for surfactants, cosmetics, detergents, fabric softeners, shampoos, conditioners, hair treatments and the like.

In particular embodiments, the blow molded articles of the present disclosure may be large part blow moldings, encompassing container sizes ranging from at least from 5 gallons (18.9 liters) up to 330 gallons (1250 liters), including at least 5 gallons (18.9 liters) to 55 gallons (208.2 liters); at least from 55 gallons (208.2 liters) up to 275 gallons (1040 liters); or at least 275 gallons (1040 liters) up to 330 gallons (1250 liters). For example, such large articles may hold volumes of 5 gallons (20 liters) in the case of Jerrycans, 30 to 55 gallons in the case of drums and 275 gallons (1040 liters) to 330 gallons (1250 liters) in the case of Industrial Bulk Containers (IBC), for example. However, it is also envisioned that the blow molded articles may also include small parts of less than 5 gallons (18.9 liters), including down to 250 milliliters. Depending on the type of the container, it is envisioned that the blow-molded products formed from the polymer compositions may be stackable or unstackable.

For stackable products, it is envisioned that the hollow blow molded products may be formed of a thickness sufficient that the formed product may be stacked for at least 28 days. A stacking test may be performed based the United Nation's Recommendations of Transport of Dangerous Goods whereby containers are subjected to a force equivalent to the total weight of filled identical packages that will be stacked during transport and storage (for example, three containers including the sample container). The test may be performed at 40 degrees C. for at least 28 days, and approval is met by no collapse in the test specimen. In one or more embodiments a blow molded article of the present disclosure (such as formed from a polyolefin polymer matrix with one or more polymer particles of a polar polymer selectively crosslinked and having an average particle size of up to 200 microns), may be stacked for a number of days that is approved in the stacking test as defined herein.

Further, the blow molded articles of the present disclosure may have a dynamic compressive strength (top load), which is a property that is correlated to the material stiffness and the container design, as measured according to ASTM D2659-16, that may be at least substantially similar with a comparative container produced with a polyolefin product.

Further, the blow molded articles of the present disclosure may also pass a drop impact test without breakage or leakage. A drop impact test may be performed according to the United Nations' Recommendations of Transport of Dangerous Goods. In such a test, containers are filled to its nominal capacity with a surrogate liquid and be conditioned at −18 degrees C. for a minimum period of 24 hours. Samples are dropped onto a rigid, non-resilient, flat and horizontal surface, from a height of 1.8 meters in the following orientations: i) flat on the bade; ii) flat on the lid; iii) flat on the longest side; iv) flat on the shortest side; and v) on a corner. One container is tested at each orientation and will pass the test if no leakage in any test specimen is detected. In one or more embodiments, a drop test may be performed based on ASTM D-2463 (Standard Test Method for Drop Impact Resistance of Blow-molded Thermoplastic Containers), wherein containers are filled to not less than 98% capacity with a surrogate liquid and be conditioned at −18 degrees C. for a minimum period of 24 hours. Samples are dropped onto a rigid, non-resilient, flat and horizontal surface, from gradually increasing heights in the bottom corner of the face next to the closure. The maximum height the test specimen can withstand without leakage is then determined. In one or more embodiments, the blow molded product of the present disclosure may have at least a substantially similar drop impact resistance than a comparative polyolefin product.

In addition to possessing more than adequate stiffness as described above, the blow molded articles may also possess better ESCR than comparative blow molded articles formed from a polyolefin without the selectively crosslinked polar polymers dispersed in the polyolefin. For stackable products, a ESCR test may be performed based on ASTM D 5571 Standard test method for environmental stress crack resistance (ESCR) of plastic tighthead drums not exceeding 60 Gal (227 L) in rated capacity , procedure B, whereby containers are filled with an ESCR agent, aqueous solution of 10 wt % of Igepal CO-630, and subjected to a temperature of 60 degree C. and subjected to a force equivalent to the total load, wherein the total load is calculated by the equation below:

Total Load (kg)=W*(3000/H−1), wherein

W is the total weight in kg calculated by the sum of the weight of the empty blow molded article and the nominal volume of the article multiplied by 1.1; and H is the article height in millimeters (mm).

Due to the Igepal degradation limit, the ESCR test undergoes through 2000 h, which is the limit of the test. In another embodiment, the blow molded products of the present disclosure may have an at least 25%, 50%, 75%, 100%, 150%, or 200% ESCR greater than a comparative polyolefin product. In such an instance, the comparative article has the same thickness as the inventive article. Thus, it is also envisioned that the blow molded article may be formed of a reduced thickness (thereby providing a significant cost savings) and have the same ESCR as a comparative polyolefin product. For example, in one or more embodiments, the wall thickness of the blow molded article of the present disclosure may be at least 5, 8, 10, or 15% thinner than a conventional blow molded article and have the same (or greater) ESCR as a comparative polyolefin.

For unstackable products, an ESCR test may be performed according to ASTM D2561, procedure A, wherein containers are filled with an ESCR agent, such as an aqueous solution of 10 wt % of Igepal CO-630 and a temperature of 60 ° C. In an embodiment, the blow molded products of the present disclosure may have an at least 25%, 50%, 75%, 100%, 150%, or 200% ESCR greater than a comparative polyolefin product. In such an instance, the comparative article has the same thickness as the inventive article. Thus, it is also envisioned that the blow molded article may be formed of a reduced thickness (thereby providing a significant cost savings) and have the same ESCR as a comparative polyolefin product. For example, in one or more embodiments, the wall thickness of the blow molded article of the present disclosure may be at least 5, 8, 10, or 15% thinner than a conventional blow molded article and have the same (or greater) ESCR as a comparative polyolefin.

Further, it is also understood that in one or more embodiments, a blow molded product of the present disclosure may possess this significantly increased ESCR with at least the same or an even better stiffness, as compared to a blow molded product formed without the selectively crosslinked polar polymer particles. Further, a measure of the blow molded products of the present disclosure may involve leakproofness, which may be tested based on the United Nations' Recommendations of Transport of Dangerous Goods. In this test, containers including their closures are kept submerged in water for 5 minutes holding a minimum internal pressure of 30 KPa provided by air flow. The test is performed in 3 containers, and if there is no leakage, the sample passes the test. In one or more embodiments, the internal pressure provided by air flow is gradually increased and the test is conducted in greater internal pressures until the leakage occurs. In one or more embodiments, the blow molded product of the present disclosure may be able to accommodate a substantially similar internal pressure without leaking.

Further, it is also understood that in one or more embodiments, a blow molded product of the present disclosure may possess this significantly increased ESCR with at least substantially similar internal hydrostatic pressure resistance (also known as burst resistance), as compared to a blow molded product formed without the selectively crosslinked polar polymer particles. The internal hydrostatic pressure resistance may be tested based on the United Nations' Recommendations of Transport of Dangerous Goods. In this test, containers including their closures shall be kept under a minimum internal pressure of 250 kPa (gauge) provided by air flow for, at least, 30 minutes. The test is performed in 3 containers, and if there is no leakage, the sample passes the test. In one or more embodiments, the internal pressure provided by air flow is gradually increased and the test is conducted in greater internal pressures until the leakage occurs. In one or more embodiments, the blow molded product of the present disclosure may accommodate substantially similar amount of internal pressure without leaking, or in one or more embodiments.

The blow molded article of the present disclosure may be a hollow molded article obtained by molding the polyolefin-based resin. As mentioned above, the hollow molded article related to the present disclosure may have a single layer as in a monolayer container or may have two or more layers as in a multilayer container. For example, when the multilayer container is formed in two layers, one layer may be formed of the polyolefin composition of the present disclosure, and the other layer may be formed of a resin different from the polyolefin composition of the present disclosure, or may be formed of the polyolefin composition of the present disclosure which has different properties from those of the polyolefin composition used in the first layer. In one or more embodiments, the polymer composition of the present disclosure may be used in any layer, but in an intermediate or outer layer, in particular embodiments. Examples of the above-mentioned different resins include polyamides (Nylon 6, Nylon 66, Nylon 12, a copolymer nylon and the like), ethylene-vinyl alcohol copolymers, polyesters (polyethyleneterephthalate and the like), PVDC (polyvinylidene chloride), polyolefins (including polyolefins without the polar particles), modified polyolefins, and the like. In one or more embodiments, the polyolefin composition of the present disclosure may be used as the outer layer of a multilayer structure, where the inner layers are formed from polyamide or a copolymer of ethylene vinyl alcohol (EVOH). In one or more embodiments, the polyolefin composition of the present disclosure may be used as the inner layer of a multilayer structure.

The hollow molded article related to the present disclosure may be prepared by a hollow molding (blow molding) method, which may include, for example, an extrusion blow molding method, a two-stage blow molding method and an injection molding method. Blow molding may be accomplished, for example, by extruding molten resin into a mold cavity as a parison or a hollow tube while simultaneously forcing air into the parison so that the parison expands, taking on the shape of the mold. The molten resin cools within the mold until it solidifies to produce the desired molded product. In one more embodiment, the blow molded product may be further subjected to a surface treatment, such as fluorination treatment or the like.

In injection blow molding, a hot preform or parison is injected into a mold, and a blowing nozzle may be inserted into the parison, through which an amount of pressurized air may be blown into the parison, forcing the parison to take the shape of the mold. Once cooled and solidified, the article may be released and finished to remove excess material. Conversely, in extrusion blow molding, the parison may be extruded downward and captured between two halves of a mold that is closed when the parison reaches proper length.

The ISBM process of one or more embodiments may comprise at least an injection molding step and a stretch-blowing step. In the injection molding step a polymer composition is injection molded to provide a preform. In the stretch-blowing step the preform is heated, stretched, and expanded through the application of pressurized gas to provide an article. The two steps may, in some embodiments, be performed on the same machine in a one-stage process. In other embodiments, the two steps may be performed separately in multiple stages.

In foam blow molding, the polymer composition may be co-extruded, depending on the final selection of the composition of each of the layers, to form a parison, wherein the composition of the present disclosure is used in the innermost layer. The extruder forming the middle layer of the multi-layer extrudate may provide for the injection of a physical blowing agent into the extruder, or when a chemical blowing agent is used, the chemical blowing agent may be mixed with the polymer being fed into the extruder. In forming a three-layer article of, three extruders may be used, and a blowing agent is only fed into to the extruder forming the middle layer which will become the foamed layer. Gas, either injected into the extruder or formed through thermal decomposition of a chemical blowing agent in the melting zone of the extruder. The gas (irrespective of the source of the gas) in the polymer forms into bubbles that distribute through the molten polymer. Upon eventual solidification of the molten polymer, the gas bubble result in a cell structure or foamed material.

The parison extruded from the machine head may be captured by a water cooled mold, and a blowing nozzle may be inserted into the parison, through which an amount of pressurized air may be blown into the parison, forcing the parison to take the shape of the mold. Once cooled and solidified, the article may be released and finished to remove excess material.

While the above describes several ways in which blow molding may be achieved, it is also understood that there is no limitation on the particular manner in which the blow molding may occur.

Definition of the Property Balance Index

Changes in physical and chemical properties of polymer compositions in accordance with the present disclosure are characterized using an index of properties that may be used to quantify the changes in a respective polymer composition based on a balance of mechanical and ESCR properties. Improvements in a material's modulus, resistance to impact and ESCR may translate to better performance in various applications. However, improvements in a single property may be offset by losses in other properties. In order to quantify the overall improvement of the material, the product of the individual properties is monitored in the examples below. The “Property Balance Index” (PBI) is defined as shown in Eq. 1 to quantify the property changes, wherein “FM” is the flexural modulus given by the secant modulus at 1% of deformation measured according to ASTM D-790 in MPa, “IR” is the IZOD impact resistance at 23 ° C., and “ESCR” is the environmental stress cracking resistance measured according to ASTM D-1693 procedure B in hours (h).

$$PBI = \frac{FM \times IR \times ESCR}{{10}^{7}} \qquad ( 1 )$$

Definition of the Normalized Property Balance Index

To compare the magnitude of property changes for different polymer systems, the PBI values were normalized according to Eq. 2, where N_{PBI} is the normalized property balance index, PBIₛₐₘₚₗₑ is the property balance index obtained for the samples of this selective reaction blend technology and PBI_{reference} is the property balance index obtained for the reference samples, i.e., a polymer composition comprising the polyolefin used in the sample.

$${N}_{PBI} = \frac{{PBI}_{sample}}{{PBI}_{reference}} \qquad ( 2 )$$

Polymer compositions in accordance with the present disclosure may exhibit an N_{PBI} higher than about 1.0 or higher than about one of 1.5, 2.0, 3.0, 5.0 and 10. In another embodiment, polymer compositions in accordance with the present disclosure may exhibit an N_{PB} falling within the range of 1.5 to 10 in some embodiments, and within the range of 3 to 9 in some embodiments.

### EXAMPLES

For the following examples, a masterbatch of the inventive composition was formulated containing 50 wt % of selectively crosslinked PVOH (Poval® 28-98 from Kuraray), 5 wt % of functionalized polyolefin (PE graftized with maleic anhydride Polybond 3029 from Addivant) and 45 wt % of HDPE (GF4950 from Braskem). Inventive compositions were prepared by the dilution of the masterbatch in the various polyethylenes and/or PCR in the inventive examples (samples B, D with 10 wt % of masterbatch and sample F with 6 wt % of masterbatch). All the inventive sample compositions were prepared in a ZSK-26 twin screw extruder at a nominal temperature screw profile of 230° C. and productivity of 15 kg/h. The inventive composition will be referenced by “modified resin” or “modified PCR” in the subsequent examples.

Samples A and C (Reference Blow Molded Articles Produced with Polyolefin—without the Addition of Masterbatch)

For the production of reference samples A, 200 kg of HDPE HS5608 (Braskem commercial grade) were blow molded in a Bekum EBM machine. When steady state process was achieved, 125 containers of 20 L were collected. The weight was adjusted in 1000 g, with a well-controlled wall thickness distribution. The Cycle per hour in all samples were 63 part/hour, and the mass temperature was around 180-190° C., usual to reference virgin HDPE. This first set of containers was considered as Sample A.

In a second step, with the remaining containers (other than the 125 containers of sample A) were ground to produce a regrind, and this regrind was mixed with virgin resin at concentration of 20 wt % of the final composition. Then, 200 kg of this composition was blow molded at the same conditions used for the Sample A. Just small adjustments were done due the change in the bulk density of this mixture, maintaining the same productivity. A set of 125 containers were collected. This second set of containers was considered as Sample C.

Samples B and D (Inventive Blow Molded Articles Produced with the Composition as Described Herein)

Using 200 kg of modified resin, 125 containers were blow molded at the same condition used in the Sample A (20 L containers). In turn, this set of containers was considered as Sample B. Using the same procedure of Sample C production, the remained containers from Sample B were ground and mixed with modified resin at concentration of 20 wt %. This blend was also blow molded at exact condition used in Sample C production. Then, 125 containers were collected. This set of containers was considered as Sample D.

Recycled Resin

The examples E and F were run in a Pavan Zanetti EBM machine, twin table, blowing canisters of 5 L, with weight of 150 g, operating at temperature around 180-190° C. usual to reference PCR (HDPE), and a productivity of 408 part/hour. No differences in processing conditions for the reference PCR were observed when using the Modified PCR.

Examples 1 to 5 are related to large volume (stackable) blow molded articles.

### Example 1

Ten specimens of each sample were conditioned for at least 40 hours at 23±2° C.

Compressive strength was determined according to ASTM D2659-16—Standard Test Method for Column Crush Properties of Blown Thermoplastic Containers. The test was performed in INSTRON dynamometer, model 5966-E2, operating at constant speed of 25 mm/min and load cell of 10 kN. The blown molded parts were positioned in upright position between two parallel flat plates. The deformation was applied in top down direction on no cap empty packages. The results at elasticity limit and maximum load points are shown in Table I.

TABLE I
Dynamic Compressive Strength

| | Sample A | Sample B | Sample C | Sample D |
|---|---|---|---|---|
| Resistance @ | 312 | 305 | 345 | 360 |
| Elasticity Limit (kgf) | | | | |
| S.D. (kgf) | 34 | 20 | 6 | 17 |
| Top Load (kgf) | 423 | 441 | 396 | 428 |
| S.D. (kgf) | 17 | 19 | 12 | 14 |
| Deformation @ | 9.6 | 8.7 | 10.4 | 10.9 |
| Elasticity Limit (mm) | | | | |
| S.D. (mm) | 1.1 | 0.6 | 0.3 | 0.6 |
| Deformation @ | 14.1 | 13.8 | 12.6 | 13.7 |
| Max. Load (mm) | | | | |
| S.D. (mm) | 1.0 | 0.8 | 0.4 | 0.6 |

### Example 2

Stacking resistance was obtained in according to UN ADR—European Agreement Concerning the international Carriage of Dangerous Goods by Road, subsection 6.1.5.6—Stacking Test. Three containers of each samples were filled with nominal volume (20 L) with water and closed with polyethylene closure. To avoid air leakage, the container was sealed with polyethylene/aluminum liner. The containers were arranged in “triangle configuration”, under a steel plate inside an oven. The total load of 890 kg was applied over the three containers. The oven temperature was adjusted in 40±1° C. The test was conducted during 28 days. After test time was completed, the containers were unloaded and left standing 24 h at room temperature. Then, the three containers were stacked. Following ADR Agreement, the test was considered as “approved” if no collapse was observed. The test, for each sample, was performed in triplicate. The results are shown in Table II.

TABLE II
ADR Stacking Test Results

| | 1° Stacking Test | 2° Stacking Test | 3° Stacking Test |
|---|---|---|---|
| Sample A | Aproved | Aproved | Aproved |
| Sample B | Aproved | Aproved | Aproved |
| Sample C | Aproved | Aproved | Aproved |
| Sample D | Aproved | Aproved | Aproved |

### Example 3

Drop test was performed in accordance with ASTM D2463—15 Standard Test Method for Drop Impact Resistance of Blow-Molded Thermoplastic Containers. Due the drop tower height limit, two procedures were applied. To evaluate Sample A and Sample B, the procedure of the variable height was applied, where the failure threshold height is calculated. For C and D samples, a second procedure was applied, where the percentage number of failed containers tested at fixed height of 5 m was reported. The containers were filled with antifreeze ethanol/water solution. The closed containers were conditioned inside a cold chamber at −18° C. for 48 h before test. Each container was removed from cold chamber and quickly tested. The chosen impact point was the bottom corner of face next to closure screw. The results are shown in Table III.

TABLE III
Drop Test - Failure Threshold

| | Failure Threshold | S.D. | Failure Percentage @ |
|---|---|---|---|
| | F50% (m) | F50% (m) | 5 m (%) |
| Sample A | 2.2 | 1.0 | |
| Sample B | 2.2 | 0.9 | |
| Sample C | >5 | — | 10 |
| Sample D | >5 | — | 35 |

### Example 4

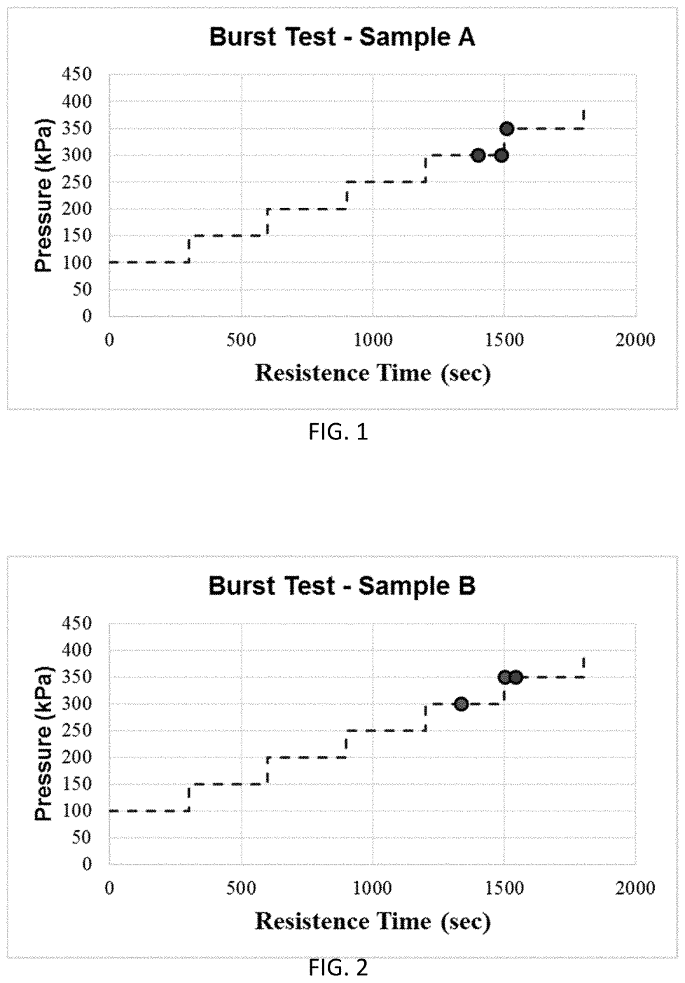

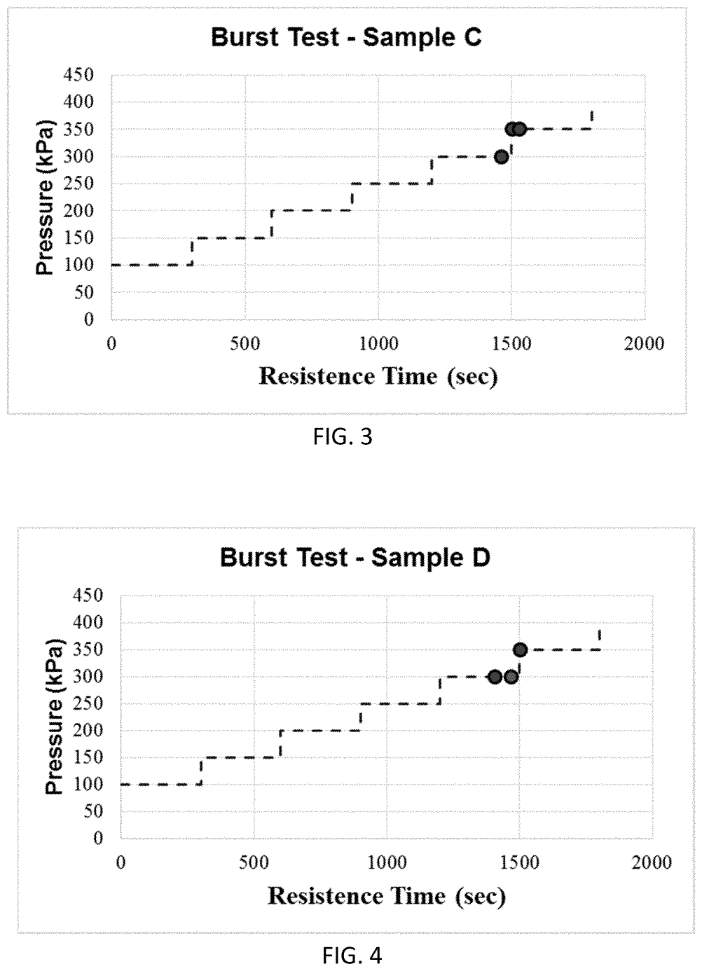

The Internal pressure (hydraulic) Test, herein called Burst Test was carried out in accordance of UN ADR—European Agreement Concerning the international Carriage of Dangerous Goods by Road, subsection 6.1.5.5—Internal Pressure Test. Since ADR Agreement is a passed/no passed test, the followed modification was applied. The test was started at initial pressure of 100 kPa, and it was thus remained for five minutes. If no failure is observed, the pressure is increased stepwise by 50 kPa, maintaining elapsed time of 5 min. at each pressure level, until a failure is observed. The elapsed time resistance during the maximum pressure level achieved is thus reported. Each sample was evaluated in triplicate. The individual failure time is shown in FIGS. 1, 2, 3 and 4. The average failure time at maximum pressure level achieved are shown in Table IV.

TABLE IV
Burst Test - Average Survival Time @ Pressure P

AVR Resistence Time @ Pressure Level (sec)

| Sample | 300 (kPa) | 350 kPa) |
|---|---|---|
| Sample A | 245 | 9 |
| Sample B | 138 | 22 |
| Sample C | 260 | 16 |
| Sample D | 239 | 1 |

### Example 5

Environmental Stress Cracking Resistance test, herein called ESCR, was based on ASTM D 5571 Standard test method for environmental stress crack resistance (ESCR) of plastic tighthead drums not exceeding 60 Gal (227 L) in rated capacity, procedure B. The followed modifications were applied. Ten containers were randomly chosen. Each container was filled at nominal capacity (20 L) with aqueous solution of Igepal CO-630 10% (w/w). Each container was hermetically sealed with polyethylene/aluminum liner and polyethylene closure. Ten containers of each sample were randomly positioned inside oven and a total load of 177 kg was applied at each individual container top. The total load was calculated according to the equation (I), and the most close load available was used in the test.

Total Load (kg)=W*(3000/H−1), (I)

where W is the total weight in kg calculated by the sum of the weight of the empty blow molded article and the nominal volume of the article multiplied by 1.1=23.06 kg; and H is the article height in millimeters (mm)=362 mm.

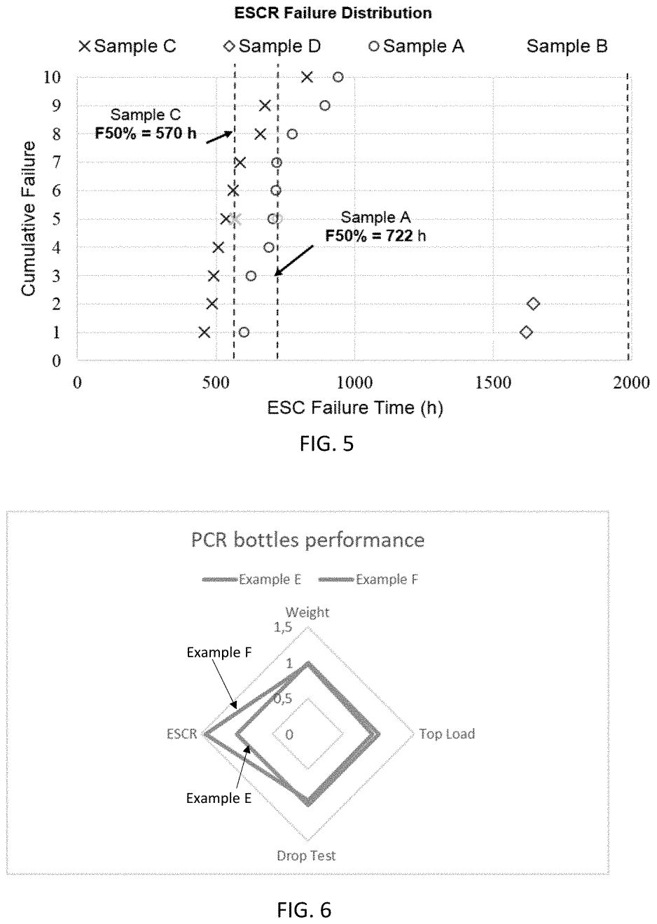

The oven temperature was adjusted in 60±2° C. To improve the failure observation, a brown paper was put under container basis. Visual inspection was performed each 8 h until that a solution leakage spot was observed. The elapsed time until the solution spot was observed was considered as failure time. The individual failure time were registered in a failure distribution plot (FIG. 5). For those samples that all specimens failed, a F50% was calculated and it was represented for a dashed line. Only two failures were observed by 2000 hr for Sample D. No failure was observed for the Sample B.

### Example 6—Low Volume (Unstackable) Blow Molded Articles

Samples E (reference article using PCR without masterbatch) and F (inventive article using modified PCR) were assayed for compressive strength according to ASTM D2659, Drop Test according to ASTM D2463 Method A, and ESCR according to ASTM D2561. The results are shown in Table V.

TABLE V
Properties measured for PCR samples

| | | Compressive | | |
|---|---|---|---|---|
| | Weight | strength | Drop Test | ESCR |
| Sample | (g) | (N) | (m) | (h) |
| E (comparative) | 150 | 43.9 | 2.84 | 17.3 |
| F (inventive) | 146 | 40 | 2.64 | 24.8 |

It is possible to observe that a similar mechanical performance of the examples and a superior ESCR to articles produced from modified PCR, bringing a superior general performance, as shown in FIG. 6.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. A blow molded article, comprising:
a polymer matrix comprising a polyolefin; and
one or more polymer particles dispersed in the polymer matrix, wherein the one or more polymer particles comprise a polar polymer selectively crosslinked with a crosslinking agent, and wherein the one or more polymer particles has an average particle size of up to 200 μm.

2. The blow molded article of claim 1, wherein the blow molded article has an environmental stress cracking resistance value that is at least 25% higher than that of a comparative blow molded article formed from the polymer matrix.

3. The blow molded articles of claim 1, wherein the polymer matrix further comprises a functionalized polyolefin.

4. The blow molded article of claim 1, wherein the polyolefin comprises a high density polyethylene having a density, measured according to ASTM D792, ranging from 0.935 to 0.970 g/cm³.

5. The blow molded article of claim 4, wherein the high density polyethylene has a melt index, measured according to ASTM D1238 at 190° C./21.6 kg, ranging from 1 to 60 g/10 min.

6. The blow molded article of any claims 4, wherein the high density polyethylene has a melt index, measured according to ASTM D1238 at 190° C./2.16 kg, ranging from 0.01 to 5 g/10 min.

7. The blow molded article of claim 1, wherein the matrix polymer comprises at least one selected from post consumer resin, post industrial resin, regrind polymer, and combinations thereof.

8. The blow molded article of claim 1, wherein the polar polymer comprises a hydroxyl functional group.

9. The blow molded article of claim 8, wherein the polar is selected from PVOH and/or EVOH.

10. The blow molded article of claim 1, wherein the blow molded article has a substantially similar compressive strength, drop impact resistance and/or internal hydrostatic pressure resistance compared to a comparative blow molded article formed from the polymer matrix.

11. The blow molded article of claim 1, wherein the blow molded article can withstand a UN stacking test for at least 28 days without collapsing.

12. The blow molded article of claim 1, wherein the blow molded article can withstand a UN burst resistance test holding at least 250 kPa without leaking.

13. The blow molded article of claim 1, wherein the blow molded article is a monolayer article.

14. The blow molded article of claim 1, wherein the blow molded article is a multilayered article comprising an innermost layer comprising:
the polymer matrix comprising a polyolefin; and
the one or more polymer particles dispersed in the polymer matrix.

15. The blow molded article of claim 1, further comprising:
one or more additives chosen from pigments, processing aids, fillers, nucleating agents, plasticizers, flame retardants and stabilizers.

16. A blow molded article comprising:
a masterbatch composition comprising a polymer matrix comprising a polyolefin and one or more polymer particles dispersed in the polymer matrix, wherein the one or more polymer particles comprise a polar polymer selectively crosslinked with a crosslinking agent, and wherein the one or more polymer particles has an average particle size of up to 200 μm; and
a secondary polymer comprising a polyolefin.

17. The blow molded article of claim 16, wherein the blow molded article has an environmental stress cracking resistance value that is at least 25% higher than that of a comparative blow molded article formed from the secondary polymer.

18. The blow molded articles of claim 16, wherein the polymer matrix further comprises a functionalized polyolefin.

19. The blow molded article of claim 16, wherein the polyolefin comprises a high density polyethylene having a density, measured according to ASTM D792, ranging from 0.935 to 0.970 g/cm³.

20. The blow molded article of claim 19, wherein the high density polyethylene has a melt index, measured according to ASTM D1238 at 190° C./21.6 kg, ranging from 1 to 60 g/10 min.

21. The blow molded article of any claims 19, wherein the high density polyethylene has a melt index, measured according to ASTM D1238 at 190° C./2.16 kg, ranging from 0.01 to 5 g/10 min.

22. The blow molded article of claim 16, wherein the matrix polymer comprises at least one selected from post consumer resin, post industrial resin, regrind polymer, and combinations thereof.

23. The blow molded article of claim 16, wherein the secondary polymer comprises at least one selected from post consumer resin, post industrial resin, regrind polymer, and combinations thereof.

24. The blow molded article of claim 16, wherein the masterbatch composition is used in an amount as low as 0.05 wt %, and the secondary polymer is used in an amount as much as 99.5 wt %, relative to the combined total of masterbatch composition and the secondary polymer.

25. The blow molded article of claim 16, wherein the blow molded article has a substantially similar compressive strength, drop impact resistance and/or internal hydrostatic pressure resistance compared to a comparative blow molded article formed from the secondary polymer.

26. The blow molded article of claim 16, wherein the blow molded article can withstand a UN stacking test for at least 28 days without collapsing.

27. The blow molded article of claim 16, wherein the blow molded article can withstand a UN burst resistance test holding at least 250 kPa without leaking.

28. The blow molded article of claim 16, wherein the blow molded article is a monolayer article.

29. The blow molded article of claim 16, wherein the blow molded article is a multilayered article comprising an innermost layer comprising:
the polymer matrix comprising a polyolefin; and
the one or more polymer particles dispersed in the polymer matrix.

30. The blow molded article of claim 16, further comprising:
one or more additives chosen from pigments, processing aids, fillers, nucleating agents, plasticizers, flame retardants and stabilizers.

31. A process for preparing an article, the process comprising:
blow molding a polymer composition to form a blow molded article, the blow molded article comprising:
a polymer matrix comprising a polyolefin; and
one or more polymer particles dispersed in the polymer matrix, wherein the one or more polymer particles comprise a polar polymer selectively crosslinked with a crosslinking agent, and wherein the one or more polymer particles has an average particle size of up to 200 μm.

32. The process of claim 20, further comprising: melt blending a masterbatch composition comprising the polyolefin in which the polymer particles are dispersed with a secondary polymer.

33. The process of claim 20, further comprising: dry blending a masterbatch composition comprising the polyolefin in which the polymer particles are dispersed with a secondary polymer.
